(19) United States
(12) Patent Application Publication
(10) Pub. No.: US 2016/0130419 A1
(43) Pub. Date: May 12, 2016

(54) PHENOLIC POLYSULPHIDES HAVING AN IMPROVED ODOUR

(71) Applicant: Arkema France, Colombes (FR)

(72) Inventor: Pascal Saint-Louis-Augustin, Billere (FR)

(73) Assignee: Arkema France, Colombes (FR)

(21) Appl. No.: 14/899,052

(22) PCT Filed: Jun. 27, 2014
(86) PCT No.: PCT/FR2014/051649

§ 371 Date: Dec. 16, 2015

(30) Foreign Application Priority Data
Jul. 1, 2013 (FR) 13.56367

(51) Int. Cl. C08K 5/00

(52) U.S. Cl. CPC C08K 5/0008

(57) ABSTRACT

The present invention concerns a composition comprising at least 50% by weight of at least one poly(phenyl sulfide) and from a few ppm to 2% by weight relative to the total volume of the composition of at least one odour-masking agent comprising at least one compound chosen from alcohols, esters, aldehydes and ketones. The invention also concerns the use of an odour-masking agent for masking the odour of a poly(phenyl sulfide), in addition to the products obtained by using the poly(phenyl sulfide) composition having a masked odour.

The present invention relates to the field of oligomers and polymers of phenol sulfides and more particularly that of the alkylphenol polysulfides, grouped together under the common name of phenolic polysulfides or poly(phenol sulfides), whose characteristic odor is masked.

The poly(phenol sulfides) are compounds that are well known and widely used in many fields of industry and notably as additives for various types of resins and other polymer materials, and for example as coupling agents, rubber accelerators, fireproofing agents, preservatives, just to mention the main uses.

They are used for example as vulcanizing agents for rubbers of the EPDM type, as described for example in patent EP1675989 or in application WO2008074962, where they are incorporated in masterbatches, as coupling agents for elastomer compositions comprising a reinforcing filler, as described for example in patent EP1633813, as butyl rubber accelerators, as described for example in application US2008/0287623, or as protective agents, notably for wood, as described for example in patent EP0944460, just to mention a few references and uses of these poly(phenol sulfides).

These poly(phenol sulfides) are most often in the form of viscous liquids, powders, granules or else formulated in polymer matrixes, for example in masterbatches of thermoplastic resins (cf. WO2008074962 discussed above), and certain of their representatives are known for example under the general name of Vultac®, marketed by the company Arkema.

Among the methods of synthesis of poly(phenol sulfides) that have proved the more cost-effective and the most used industrially, we may mention the methods consisting of reacting a phenol or an alkylphenol with:
sulfur monochloride (S₂Cl₂) or sulfur dichloride (SCl₂) in the presence or absence of a solvent, as described for example in patents U.S. Pat. No. 5,827,806 and U.S. Pat. No. 6,303,746,
sulfur in the presence or absence of a solvent and optionally of a base mineral, as described for example in patent EP1123930.

Depending on the method used, the reactions employed may generate undesirable byproducts, among which we may mention chlorinated phenolic compounds, for example chlorophenols and chloro-(alkyl)phenols, but also sulfur and sulfur compounds, such as thiophene derivatives, for example 3-methylthiophene, or such as mercaptans, for example mercapto-alkylphenols. Moreover, phenol and/or residual alkylphenols, hydrochloric acid, and other impurities may still be present in the end product.

Even working with very selective methods, with conditions minimizing the formation of such byproducts, and after purification of the end product using one or more purification techniques known by a person skilled in the art, such as distillation, recrystallization and others, very small amounts of the aforementioned impurities and undesirable products may still be present in the end product.

Now, these impurities and undesirable products are notably responsible for the unpleasant, foul-smelling, strong, or even pungent odors released by certain poly(phenol sulfides) used today, in particular in the various products prepared from, or treated with, or comprising said poly(phenol sulfides). Industry is also sometimes reluctant to use the poly(phenol sulfides), despite their great efficacy and their very good properties, because the users of the finished products may be bothered by the residual odors of said poly(phenol sulfides) in said finished products.

These unpleasant or even foul-smelling odors could lead industry to prefer other additives that generate less foul-smelling odors, but which might prove less effective than the poly(phenol sulfides).

Consequently there is still a need for compounds of the poly(phenol sulfide) type that are less odorous, or at least whose odors released are less pungent, or even more pleasant, or even almost nonexistent or else masked, so as to have at our disposal poly(phenol sulfides) that are more pleasant to use, and finished products free from odors or whose odors from poly(phenol sulfides) are masked.

The applicant discovered that it is possible to mask the odors, or else odorize, the poly(phenol sulfides) in order to allow their uses and the uses of the products manufactured from said poly(phenol sulfides), without being inconvenienced by the intrinsic odors of these poly(phenol sulfides), and without adversely affecting their properties, i.e. while preserving their properties.

The removal or masking of odors of organic, artificial or synthetic products is a field that is well known and widely described in the prior art. In this connection, we may mention in particular application US2011/0024678, which describes odor masking of organic sulfur compounds, such as the dialkyl sulfides, disulfides and polysulfides or their oxidized counterparts, as well as patent U.S. Pat. No. 5,559,271, which describes more precisely odor masking of organic polysulfides of general formula R—Sₓ—R, where R is an aliphatic radical.

In contrast to the poly(phenol sulfides), these compounds of the prior art possess a sulfur atom joined to an alkyl radical, and both their chemical structures and their methods of preparation are sufficiently different so that the odors that they release are of a totally different nature from those of said poly(phenol sulfides).

Thus, at present the prior art does not offer a satisfactory solution for removing, or at least masking, the odor or odors of the poly(phenol sulfides) and derivative products that contain them or from which they have been manufactured.

Surprisingly, the applicant discovered that it is possible to mask, completely or at least partly, the odors of poly(phenol sulfides) by adding to them a very small amount of at m least one odor masking agent. Addition of at least one odor masking agent to at least one poly(phenol sulfide) makes it possible to obtain a composition comprising said at least one poly(phenol sulfide) or a product prepared from said at least one such poly(phenol sulfide), whose odor has disappeared, has been masked, or at least whose odor is much less unpleasant. This odor masking thus allows handling to be easier and less restrictive is for the user, and also makes it possible to prepare finished products whose odors are less unpleasant and less troublesome for the end users.

Thus, according to a first aspect, the present invention relates to a composition comprising:
a) at least 50 wt % and preferably at least 70 wt %, more preferably at least 80 wt %, especially preferably at least 90 wt % of at least one poly(phenol sulfide); and
b) a few ppm, advantageously 10 ppm, at 2 wt %, preferably 10 ppm at 1 wt % relative to the total weight of the composition, of at least one odor masking agent comprising at least one compound selected from b1) alcohols, b2) esters, b3) aldehydes, b4) ketones and b5) ethers.

In the context of the present invention, poly(phenol sulfide) means the oligomers or polymers corresponding to the following formula (1):

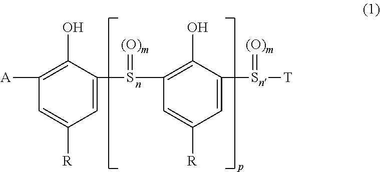

in which:
R represents a hydrogen atom or a hydrocarbon-containing group, linear, branched and/or cyclic, fully or partially saturated or unsaturated, comprising from 1 to 20 carbon atoms;
n and n′, which may be identical or different, represent independently of one another an integer greater than or equal to 1, preferably between 1 and 8, more preferably between 1 and 6, more preferably between 1 and 4, inclusive;
p represents an integer between 0 and 100, preferably between 0 and 50, more preferably between 0 and 40 inclusive;
A represents a hydrogen atom, and T represents a radical of formula (2):

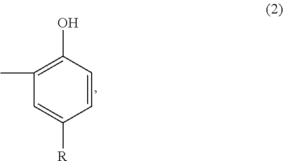

or else, only when p is strictly greater than 0, A and T together may form a single bond, so as to form a cyclic poly(phenol sulfide); and
m represents 0, 1 or 2.

The compounds of formula (1) are preferred in which R represents a linear or branched alkyl radical comprising from 1 to 20 carbon atoms, preferably from 1 to 12 carbon atoms. According to a preferred embodiment, the radical R is selected from the methyl, ethyl, n-propyl, iso-propyl, n-butyl, isobutyl, tert-butyl, n-pentyl, amyl, iso-amyl, tert-amyl, hexyl, heptyl, octyl and nonyl radicals. The radical R may also be substituted with one or more cyclic groups, for example with an aromatic group, and typically R may represent a phenylprop-2-yl radical, as described in application US2007/0093613.

Moreover, the compounds of formula (1) are preferred for which n and n′, which may be identical or different, are selected independently of one another from 1, 2, 3 and 4, and preferably n and n′ are selected independently of one another from 2, 3 and 4, and especially preferably n and n′ each represent the integer 2.

Moreover, the compounds of formula (1) are preferred in which n and n′ each represent the number 1, when m represents 1 or 2. In a preferred embodiment of the invention, the compounds of formula (1) are those in which m represents 0.

According to another embodiment, the compounds of formula (1) are preferred for which p represents an integer between 1 and 40, preferably between 2 and 30, more preferably between 3 and 25 inclusive.

It has to be understood that the composition according to the present invention may comprise more than one poly(phenol sulfide) of formula (1) and in particular several poly(phenol sulfides) for which n and n′, which may be identical or different, are selected independently of one another from 2, 3 and 4. In such mixtures of poly(phenol sulfides), the average value of n and the average value of n′ are preferably each close to 2.

Moreover, when several poly(phenol sulfides) are comprised in the composition according to the present invention, the values p of the poly(phenol sulfides) may be identical to or different from one another, and the average value of p, in such mixtures of poly(phenol sulfides), may typically be from about 5 to about 10, inclusive.

According to yet another embodiment, the composition according to the present invention may be formulated with one or more additives or fillers, among which we may mention the fatty acids, for example stearic acid, silica, for example silica gel, urea and urea derivatives.

The poly(phenol sulfides) used in the compositions according to the present invention are familiar to a person skilled in the art and may be quite particularly the poly(phenol sulfides) marketed by the company Arkema under the general name Vultac®, among which we may mention Vultac® 2, Vultac® 3, Vultac® 5, Vultac® TB7, Vultac® 700, Vultac® 710, Vultac® TB710, and other Vultac® products.

Other similar poly(phenol sulfides) may also be mentioned, such as GUS-34 and GUS-37 marketed by M&B GreenUS Co. Ltd., RPS2, RPS5A, RPS5B, RPS700, RPS710 marketed by Jinan Evergrowing Rubber Additive Co. Ltd., Tackirol AP and Tackirol V200 marketed by the company TAOKA Chemical Co., the Ethanox® products, and in particular Ethanox® 323 and Ethanox® 323A from the company Albemarle, as well as Dragonox 323 from the company Flying Dragon and GY 323 from Guangzhou Research Institute.

Thus, components a) of the composition according to the present invention, in particular the Vultac® products, are readily available commercially or can be prepared by any methods known by a person skilled in the art, and described in the scientific and patent literature.

It has to be understood that the invention also relates to the compositions comprising the derivatives of poly(phenol sulfides) of formula (1) described above and notably the compounds of formula (1) in which the hydroxyl function of the phenol has been modified (for example alkoxylated) and/or the radicals R of the phenol groups have been modified (for example substituted, functionalized, etc.).

It has now been discovered that the odor of the poly(phenol sulfides) (component a) of the composition of the invention) can be masked effectively by adding at least one odor masking agent (component b) of the composition of the invention).

The amount of masking agent (component b)) may vary widely in the range stated above, depending on the desired effect, the intensity of the odor to be masked, the respective residual contents of the various impurities that may be present in the component(s) a) defined above, and others.

Amounts of masking agent less than a few ppm may be too low to obtain the desired effect. Amounts of masking agent above 2% may be prohibitive from the economic standpoint, or may have harmful effects depending on the intended applications for the poly(phenol sulfides), which will be described later in the description.

Preferably, and non-exhaustively, the content of odor masking agent(s) b) is between 0.001 and 1 wt % inclusive, relative to the total weight of the composition, preferably between 0.001 and 0.5 wt % inclusive, for example about 0.1 wt %.

The present invention offers the advantage of masking the unpleasant odor of at least one poly(phenol sulfide), without altering its nature chemically. Thus, the present invention proposes a composition comprising a) a predominant amount of at least one poly(phenol sulfide) of formula (1), or at least one poly(phenol sulfide) derivative of formula (1), to which is added a minor amount of a composition b) masking the unpleasant odor of the component or components a).

The odor-masked composition according to the present invention may be prepared by any method known per se by simply combining at least one component a) with at least one odor-masking composition b). For example at least one composition b) may be added to at least one component a), or vice versa, optionally with stirring and/or optionally with heating.

More generally, any known method of mixing and/or of heating may be used. The composition according to the invention may for example be prepared at atmospheric pressure, at a temperature between 0° C., preferably between room temperature, and 250° C. to 300° C. from component a), when the latter is in solid form. It is quite particularly preferred to carry out the mixing at a temperature above the melting point of component a). Preparation may also be carried out under pressure or under negative pressure, at temperatures within the ranges stated above.

As a variant, and according to a preferred embodiment, component b) may be added during synthesis of component a), and quite particularly at the end of synthesis of component a), when it is still in the molten state, or to the reaction solvent, before recovering component a) in solid form, when component a) is in solid form at ambient temperature and pressure.

The length of time required for preparing the odor-masked composition according to the invention varies depending on the nature and the amount of the component or components a) and of the composition or compositions b), but also as a function of the temperature and pressure selected. As a general rule, the length of time corresponds to the time required to obtain a homogeneous mixture and to produce the required odor-masking effect of the component or components a); it is generally between seconds and minutes, or even one or more hours. The aforementioned method of preparation may be carried out in batches (“batch” process) or continuously.

As stated above, the odor masking agent b) comprises one or more of the compounds selected from:
b1) alcohols;
b2) esters;
b3) aldehydes;
b4) ketones; and
b5) ethers.

The odor masking agent thus comprises at least one alcohol b1), which may be of any type and advantageously is selected from the monohydric alcohols, comprising from 1 to 40 carbon atoms, preferably from 6 to 35 carbon atoms, more preferably from 8 to 30 carbon atoms, said carbon atoms forming a linear or branched chain optionally comprising one or more unsaturation(s) in the form of double bond(s), and optionally comprising a cyclic structure with 5 or 6 ring members, saturated, or fully or partially unsaturated.

As illustrative but nonlimiting examples of alcohols b1), we may mention preferably the monohydric alcohols, whose hydroxyl function is preferably carried by an sp² carbon atom, and among the latter those optionally further comprising at least one aryl radical. “Aryl radical” means an aromatic hydrocarbon-containing radical, preferably selected from phenyl and naphthyl, optionally substituted with one or more groups preferably selected from alkyl, alkenyl, alkoxy, carbonyl and alkoxycarboyl. Preferably the aryl radical is a phenyl radical.

Thus, component b1) is preferably an alcohol comprising an aryl radical, more preferably a primary alcohol comprising an aryl radical, and quite especially preferably a hydroxyalkylbenzene, for example selected from, but not limited to, benzyl alcohol, phenylethanol, propylethanol, butylethanol, and others, as well as mixtures of two or more of them in all proportions.

It must be understood that the phenols used as the starting product in the synthesis of the poly(phenol sulfide) of formula (1) as described above do not form part of the alcohols b1) of the odor masking agent b).

However, phenols substituted with one or more alkoxy groups may be used as alcohol b1). Among these alkoxyphenols, we may mention for example, nonexhaustively, 2-methoxyphenols, and in particular 2-methoxyphenols substituted in position 4 with an alkyl or alkenyl radical, where alkyl and alkenyl comprise the methyl, ethyl, propyl, butyl, pentyl, hexyl, propenyl, butenyl, pentenyl and hexenyl radicals, the plural form of these radicals indicating that their isomers are included in this nonexhaustive list.

The esters b2) of the odor masking agent b) present in the composition of the invention may in general be of all types known by a person skilled in the art, but the esters of the alcohols b1) listed above are quite particularly preferred, i.e. the esters of monohydric primary alcohols, preferably comprising an aromatic ring and more preferably the esters formed from hydroxyalkylphenols.

As illustrative but nonlimiting examples of esters mentioned under b2), we may mention the esters of C₂-C₂₀ acids, saturated or unsaturated, such as acetates, propionates, butyrates, methylbutyrates, pentanoates, hexanoates, heptanoates, benzoates, hydroxybenzoates, cyclopropylcarboxylates, cyclobutylcarboxylates, cyclopentylcarboxylates, cyclohexylcarboxylates, citrates, caproates, oleates, linoleates, linolenates, of alkyl (linear or branched, for example of ethyl, propyl, butyl, pentyl, 2-methylbutyl, iso-amyl, hexyl), of alkenyl (linear or branched comprising from 3 to 12 carbon atoms), of aryl (for example of benzyl, of phenylethyl), of terpene derivatives (for example of menthyl, of carvyl), and others, and mixtures thereof.

Among the esters b2), we may also mention the cyclic esters or lactones, also called alkanolides. The alkanolides not comprising a double bond and the alkanolides comprising a single endocyclic double bond are preferred.

Among the esters b2), the following are more particularly preferred, as nonlimiting examples: benzyl acetate, phenylethyl acetate, methyl 2-hydroxybenzoate, benzyl 2-hydroxybenzoate, the butyrolactones, and the alkanolides comprising from 6 to 12 carbon atoms, for example the decanolides, undecanolides, dodecanolides, cyclopentadecanolides, oxacyclohexadecenones, as well as the pyranones, and benzopyranones, and mixtures of two or more of these compounds.

The odor masking agent b) may further comprise at least one aldehyde b3) and/or at least one ketone b4), and preferably at least one aldehyde and/or at least one ketone corresponding to formula R^{a}—CO—R^{b}, in which R^{a} represents a hydrocarbon chain comprising from 1 to 20 carbon atoms, linear, branched or cyclic, saturated or partially or fully unsaturated, optionally substituted with one or more radicals selected from hydroxy, alkoxy, aryl, and R^{b} represents a hydrogen atom (in the case of the aldehydes), or else (in the case of the ketones) a hydrocarbon chain from 6 to 12 carbon atoms, linear, branched or cyclic, saturated or partially or fully unsaturated, optionally substituted with one or more radicals selected from hydroxy, alkoxy, cycloalkyl, cycloalkenyl, and aryl, aryl being as defined above.

As illustrative but nonlimiting examples of aldehydes b3), we may mention preferably propanal, butanal, pentanal, hexanal, heptanal, octanal, nonanal, decanal, undecanal, dodecanal, benzaldehyde, geranial, neral, citronellal, as well as the substituted homologs thereof, for example the hydroxydecanals, phenylpropanals, phenylbutanals, phenylpentanals, phenylhexanals, hydroxybenzaldehydes, alkoxybenzaldehydes, and others, as well as the substituted homologs thereof, and mixtures of two or more of these aldehydes, in all proportions.

As illustrative but nonlimiting examples of ketones b4), we may mention preferably propanone, butanone, pentanone, hexanone, heptanone, octanone, nonanone, decanone, undecanone, dodecanone, and preferably the substituted homologs thereof, as well as the cyclic ketones, among which we may mention menthone, iso-menthone, ionones, methylionones, phenylethanones, benzopyranones, 1,8-cineole, ascaridole, flavonone, calone, galbascone, and others, as well as the substituted homologs thereof, and mixtures of two or more of these ketones, in all proportions.

“Substituted homologs” means the aforementioned aldehydes and ketones substituted with one or more radicals, which may be for example, nonexhaustively, selected from the alkyl, hydroxy, aryl, aralkyl radicals. Examples of these substituted homologs comprise, nonexhaustively, 3-(4-ethylphenyl)-2,2-dimethylpropanal, 3-(2-ethylphenyl)-2,2-dimethylpropanal, 7-hydroxydecanal, 7-hydroxy-3,7-dimethyloctanal, 2-methoxybenzaldehyde, 4-methoxybenzaldehyde, 4-(4-hydroxyphenyl)butan-2-one, and others, and mixtures thereof.

The odor masking agent b) may further comprise at least one ether b5), and preferably at least one ether corresponding to formula R′^{a}—O—R′^{b}, which R′^{a} and R′^{b}, which may be identical or different, represent, independently of one another, a hydrocarbon chain comprising from 1 to 20 carbon atoms, linear, branched or cyclic, saturated or partially or fully unsaturated, optionally substituted with one or more radicals selected from hydroxy, alkoxy, cycloalkyl, cycloalkenyl and aryl, aryl being as defined above.

As illustrative but nonlimiting examples of ethers b5), which may be symmetric or asymmetric, cyclic or acyclic, we may mention preferably the dialkyl ethers, optionally substituted (for example the bis-hydroxypropyl ethers), pyrans, furans, benzopyrans, benzofurans, naphthopyrans, naphthofurans, and others, as well as the substituted homologs thereof, and mixtures of two or more of these ethers, in all proportions.

Moreover, the odor masking agent b) usable in the context of the present so invention may comprise, in minor amounts, other agents (fragrances) usually employed in the field of perfumery, such as fatty acids, glycols, terpene compounds, and others familiar to a person skilled in the art.

The composition b) intended to mask the poly(phenol sulfide) odor, and as described above, may, if applicable, or if necessary, further comprise one or more additives commonly used in this field. Such additives may for example be selected from, but are not limited to, solvents, pigments, dyes, preservatives, biocides, and others.

Among the solvents, examples that are quite particularly preferred are alcohols, ethers, esters and glycols. Particularly advantageously, the solvent is selected from diethyl phthalate, ethylene glycol, propylene glycol, diethylene glycol, dipropylene glycol, the polyethylene glycols, the polypropylene glycols, and mixtures thereof, and even more advantageously from diethyl phthalate, dipropylene glycol, and mixtures thereof.

According to a preferred aspect, the odor masking agent used in the composition of the present invention is selected from the odor masking agents comprising:
at least one component b1);
at least one component b1) and at least one component b2);
at least one component b1) and at least one component b3);
at least one component b1) and at least one component b4);
at least one component b1) and at least one component b5);
at least one component b1), at least one component b2) and at least one component b3);
at least one component b1), at least one component b2) and at least one component b4);
at least one component b1), at least one component b2) and at least one component b5);
at least one component b1), at least one component b3) and at least one component b4);
at least one component b1), at least one component b3) and at least one component b5);
at least one component b1), at least one component b4) and at least one component b5);
at least one component b1), at least one component b2), at least one component b3) and at least one component b4);
at least one component b1), at least one component b2), at least one component b3) and at least one component b5);
at least one component b1), at least one component b2), at least one component b3), at least one component b4) and at least one component b5);
at least one component b2);
at least one component b2) and at least one component b3);
at least one component b2) and at least one component b4);
at least one component b2) and at least one component b5);
at least one component b2), at least one component b3) and at least one component b4);
at least one component b2), at least one component b3) and at least one component b5);
at least one component b2), at least one component b4) and at least one component b5);
at least one component b2), at least one component b3), at least one component b4) and at least one component b5);
at least one component b3);
at least one component b3) and at least one component b4);
at least one component b3) and at least one component b5);
at least one component b3), at least one component b4) and at least one component b5);
at least one component b4);
at least one component b4) and at least one component b5); and
at least one component b5).

According to an even more preferred aspect, the odor masking agent used in the composition of the present invention is selected from the odor masking agents that comprise:
at least one component b1), at least one component b2) and at least one component b3);
at least one component b1), at least one component b2) and at least one component b4);
at least one component b1), at least one component b2) and at least one component b5);
at least one component b1), at least one component b2), at least one component b3) and at least one component b4);
at least one component b1), at least one component b2), at least one component b3) and at least one component b5);
at least one component b1), at least one component b2), at least one component b3), at least one component b4) and at least one component b5);
at least one component b2), at least one component b3), and at least one component b4);
at least one component b2), at least one component b3), at least one component b4), and at least one component b5); and
at least one component b2), at least one component b4), and at least one component b5).

As stated above, the composition according to the present invention comprises at least one composition of odor masking agent b). According to one embodiment, said agent comprises at least one component b1) and/or at least one component b2) and/or at least one component b3), each of the components b1), b2) and b3), when it is present, is present in an amount greater than or equal to 1 wt %, preferably greater than or equal to 10 wt %, relative to the total weight of the odor masking agent b).

According to another preferred embodiment, the composition according to the present invention comprises at least one composition of odor masking agent b) comprising at least one component b2) and/or at least one component b4) and/or at least one component b5), each of the components b2), b4) and b5), when it is present, is present in an amount greater than or equal to 1 wt %, preferably greater than or equal to 10 wt %, relative to the total weight of the odor masking agent b).

The odor masking agents b) are also preferred which, when they comprise at least one ketone b4), comprise an amount of ketone(s) b4) between 0.1 and 40 wt %, preferably between 0.1 and 10 wt % inclusive, relative to the total weight of the odor masking agent.

The odor masking agent b) may optionally also comprise up to 20 wt %, preferably from 0.1 to 10 wt %, more preferably from 0.1 to 1 wt %, relative to the total weight of the odor masking agent, of at least one fragrance usually employed in the field of perfumery.

According to a preferred embodiment, the odor masking agent b) comprises:
at least 1 wt %, and preferably at least 10 wt %, of at least one alcohol b1),
at least 1 wt %, and preferably at least 10 wt %, of at least one ester b2),
at least 1 wt %, and preferably at least 10 wt %, of at least one aldehyde b3), and
the complement to 100% comprising at least one ketone b4) and/or at least one ether b5) and/or one or more other fragrances and/or additives, as stated above.

An odor masking agent b) typically suitable for the poly(phenol sulfides) according to the present invention comprises by weight:
at least 1 wt %, and preferably at least 10 wt %, of at least one alcohol b1), selected from benzyl alcohol, phenylethanol, propylethanol and butylethanol, and mixtures thereof in all proportions,
at least 1 wt %, and preferably at least 10 wt %, of at least one ester b2), selected from benzyl acetate, phenylethyl acetate, methyl 2-hydroxybenzoate, benzyl 2-hydroxybenzoate, the butyrolactones, and the hexanolides comprising from 6 to 12 carbon atoms, and mixtures thereof in all proportions,
at least 1 wt %, and preferably at least 10 wt %, of at least one aldehyde b3), selected from 3-(4-ethylphenyl)-2,2-dimethylpropanal, 3-(2-ethylphenyl)-2,2-dimethylpropanal, 7-hydroxydecanal, 7-hydroxy-3,7-dimethyloctanal, 2-methoxybenzaldehyde, 4-methoxybenzaldehyde, and mixtures thereof in all proportions, and
the complement to 100% comprising at least one ketone b4) and/or at least one ether b5) and/or one or more other fragrances and/or additives, as stated above.

This composition, designated Cl hereinafter, is quite particularly suitable for masking the odor, for improving the odor, of the poly(phenol sulfides) of formula (1) described above (component a), and in particular of the poly(phenol sulfides) marketed by the company Arkema under the general name of Vultac®.

According to yet another preferred embodiment, the odor masking agent b) comprises:
at least 1 wt %, and preferably at least 10 wt %, of at least one ester b2),
at least 1 wt %, and preferably at least 10 wt %, of at least one ketone b4),
at least 1 wt %, and preferably at least 10 wt %, of at least one ether b5), and
the complement to 100% comprising at least one alcohol b1) and/or at least one aldehyde b3) and/or one or more other fragrances and/or additives, as stated above.

An odor masking agent b) corresponding to this embodiment and typically also suitable for the poly(phenol sulfides) according to the present invention, comprises by weight:
at least 1 wt %, and preferably at least 10 wt %, of at least one ester b2) selected from the cyclic esters of the alkanolide type, as defined above,
at least 1 wt %, and preferably at least 10 wt %, of at least one ketone b4), selected from menthone, iso-menthone, ionones, methylionones, phenylethanones, benzopyranones, 1,8-cineole, ascaridole, flavonone, calone, galbascone, and others, as well as the substituted homologs thereof, and mixtures of two or more of these ketones, in all proportions,
at least 1 wt %, and preferably at least 10 wt %, of at least one ether b5), selected from the dialkyl ethers, optionally substituted (for example the bis-hydroxypropyl ethers), pyrans, furans, benzopyrans, benzofurans, naphthopyrans, naphthofurans, and others, as well as the substituted homologs thereof, and mixtures of two or more of these ethers, in all proportions, and
the complement to 100% comprising at least one alcohol b1) and/or at least one aldehyde b3) and/or one or more other fragrances and/or additives, as stated above.

This composition, designated C2 hereinafter, is also quite particularly suitable for masking the odor, for improving the odor, of the poly(phenol sulfides) of formula (1) described above (component a), and in particular the poly(phenol sulfides) marketed by the company Arkema under the general name of Vultac®.

These compositions of agents for masking the odor of the poly(phenol sulfides) of formula (1), and in particular the compositions C1 and C2 described above, are given as examples and have nothing restrictive as to the potential diversity of the compositions provided by the present invention defined on the basis of the appended claims.

A quite particularly preferred composition according to the present invention comprises:
a) at least 50 wt % and preferably at least 70 wt %, more preferably at least 80 wt %, especially preferably at least 90 wt % of at least one poly(phenol sulfide) of formula (1) as defined above; and
b) a few ppm, advantageously 10 ppm, at 2 wt %, preferably 10 ppm at 1 wt % relative to the total volume of the composition, of at least one composition Cl or composition C2, as defined above.

According to another aspect, the present invention relates to the use of at least one odor masking agent b) as has just been defined for attenuating or else masking the odor of at least one poly(phenol sulfide), or of a composition comprising at least one poly(phenol sulfide), notably a poly(phenol sulfide) of formula (1) as defined above, and in particular a poly(phenol sulfide) of the Vultac® class marketed by the company Arkema.

The compositions according to the present invention comprising predominantly at least one poly(phenol sulfide) a) and at least one odor masking agent b) find particularly advantageous uses in many areas, and in particular in all the known areas of use of the poly(phenol sulfides).

Thus, the odor-masked compositions according to the invention may for example be used, as nonlimiting examples, as antioxidants and/or thermal stabilizers for plastics or for oils, as flame retardants for plastics or else for synthetic or vegetable fibers, as protective agents for wood, as agents for dismutation and bleaching of vegetable resins, as charge control agents for toner, and others, just to mention a few principal uses.

The various products obtained using an odor-masked composition according to the invention also have an attenuated odor, or do not have any unpleasant or irritant odor. In fact, surprisingly, the odor masking agent present in the composition according to the invention remains stable and allows products to be obtained, even when they are prepared at temperatures between 25 and 300° C., and do not themselves have an unpleasant odor for the end user, as is perceived when they are prepared with compositions of poly(phenol sulfides) that are not odor-masked.

According to yet another aspect, the present invention relates to a manufactured product prepared with at least one composition according to the present invention. Examples of such products are, as nonlimiting examples, elastomer-based products, such as tires or parts of tires, for example tire tread, inner lining, etc., products based on thermoplastic resins, including masterbatches comprising a polymer and at least one composition of poly(phenol sulfide) according to the invention, for example the masterbatches marketed by the company MLPC under the trade name Mixland®, for example those in which a mixture of poly(phenol sulfide) and urea is dispersed and to which at least one odor masking agent b) according to the invention may be added.

Among the products manufactured and prepared with at least one composition according to the present invention, we may also mention products based on rosin, based on vegetable fibers, such as cotton or wool, products based on polystyrene foam, components of toners for printing, products based on wood treated with poly(phenol sulfides), and others.

The present invention is now illustrated by the examples given hereunder, which are presented without any intention of limiting the various embodiments of the invention.

### EXAMPLE 1

Odor-masked composition based on poly(phenol sulfide)

In order to characterize the odor-masked compositions according to the invention, an olfactory test procedure was elaborated. This procedure provides a hedonic classification of different compositions.

### Operating Conditions:

For carrying out this olfactory test, 30-liter polyethylene (PE) drums are used, each equipped with a cover in which a flap of about 10 cm×10 cm is cut, allowing an operator (panellist) to smell the vapors contained in the drum.

A crystallizing dish containing about 25 grams of test composition is put in each of the drums. The drums are kept closed for 24 hours at room temperature. The evaluation is then carried out blind.

The panellists, 10 in number, take turns testing a few products per session (at most 3 products per session). They begin by smelling the drum holding the reference poly(phenol sulfide) (without odor masking agent), and then one of the test compositions. The reference poly(phenol sulfide) is Vultac® 3 marketed by the company Arkema. This sample is designated V.

Depending on their preference, the panellists assign a score to each of the test compositions, relative to the reference, which arbitrarily receives the score 5. The scores given by the panellists range from 1 (the most pleasant product) to 10 (the most unpleasant product).

### Preparation of the Test Samples:

A known amount of Vultac® 3 (about 25 grams) is put in a stove at a temperature of 165° C., in an aluminum dish. When the Vultac® 3 has melted and is perfectly stirrable, a given amount of an odor masking agent is introduced using a pipette. It is stirred with a glass rod for 1 min.

After 10 minutes, it is stirred again for 1 min. The whole is put back in the stove for 15 min. It is then left to cool to room temperature and the odorized Vultac® 3 is recovered.

The samples are then tested according to the protocol described above. The samples prepared are detailed in the following Table 1:

TABLE 1

| | | | Amount of odor |
|---|---|---|---|
| | Amount of | Odor masking | masking agent |
| Sample | Vultac ® 3 (g) | agent | (mg, wt %) |
| V | 25.10 | — | — |
| 1 | 25.30 | C1 | 25 mg, or 0.1% |
| 2 | 25.33 | C1 | 63 mg, or 0.25% |
| 3 | 25.25 | C1 | 126 mg, or 0.5% |
| 4 | 25.31 | C2 | 25 mg, or 0.1% |
| 5 | 25.20 | C2 | 63 mg, or 0.25% |
| 6 | 25.25 | C2 | 126 mg, or 0.5% |
| 7 (comparative) | 25.20 | limonene | 25.5 mg, or 0.1% |
| 8 (comparative) | 25.15 | β-pinene | 25.7 mg, or 0.1% |

The results of the olfactory test are presented in the following Table 2:

TABLE 2

| | | Standard | |
|---|---|---|---|
| Test sample | Mean value | deviation | Group |
| V | 5 | 0 | A |
| 1 | 2.5 | 1.3 | A |
| 2 | 3.1 | 1.4 | A |
| 3 | 3.8 | 1.2 | A |
| 4 | 2.6 | 1.3 | A |
| 5 | 2.8 | 1.6 | A |
| 6 | 4.0 | 1.8 | B |
| 7 (comparative) | 4.2 | 2.4 | B |
| 8 (comparative) | 4.5 | 2.0 | B |

Statistical analysis of these results, performed using the software FIZZ version 2.01 (Biosystems, Couternon, France), makes it possible to calculate the standard deviation and classify the samples in two groups by studying the LSD (least significant difference) fixed in this test at 1.05. This statistical test for comparing mean values makes it possible to determine, from a statistical standpoint, whether the mean values of two samples are significantly different. In the above examples, the statistical parameterization used is fixed at 95%.

If the mean values are not significantly different, the two samples are classified in one and the same group. If the mean values are significantly different, the two samples constitute two separate groups (A and B in the examples illustrating the invention).

The same operation is carried out for comparing all the samples, which finally gives 1, 2 or more groups, each consisting of samples whose average scores are not significantly different.

The results presented in Table 2 above show that there is a significant statistical difference indicating far more pleasant odor perception of the samples comprising an odorized composition according to the invention, relative to the reference (non-odorized poly(phenol sulfide)). However, a poly(phenol sulfide) odorized only with a terpene (limonene or β-pinene, not according to the invention) does not have a sufficiently masked odor.

1. A composition comprising:
a) at least 50 wt % of at least one poly(phenol sulfide); and
b) from a few ppm to 2% by weight relative to the total weight of the composition of at least one odor masking agent comprising at least one compound selected from the group consisting of b1) alcohols, b2) esters, b3) aldehydes, b4) ketones and b5) ethers.

2. The composition as claimed in claim 1, wherein said at least one poly(phenol sulfide) corresponds to the following formula (1): 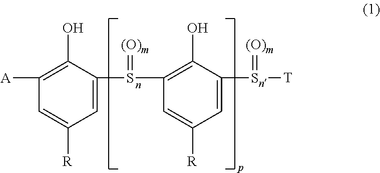
in which:
R represents a hydrogen atom or a hydrocarbon-containing group, linear, branched and/or cyclic, fully or partially saturated or unsaturated, comprising from 1 to 20 carbon atoms;
n and n′, which may be identical or different, represent independently of one another an integer greater than or equal to 1;
p represents an integer between 0 and 100;
A represents a hydrogen atom, and T represents a radical of formula (2): 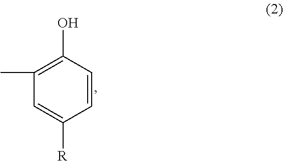
or else, only when p is strictly greater than 0, A and T together may form a single bond, so as to form a cyclic poly(phenol sulfide); and
m represents 0, 1 or 2.

3. The composition as claimed in claim 1 additionally comprising one or more additives or fillers.

4. The composition as claimed in claim 1, wherein the odor masking agent b) comprises at least one alcohol b1) selected from the group consisting of monohydric alcohols, comprising from 1 to 40 carbon atoms, said carbon atoms forming a linear or branched chain optionally comprising one or more unsaturation(s) in the form of double bond(s), and optionally comprising a cyclic structure with 5 or 6 ring members, saturated, or fully or partially unsaturated.

5. The composition as claimed in claim 1, wherein the odor masking agent b) comprises at least one alcohol b1) selected from the group consisting of benzyl alcohol, phenylethanol, propylethanol, butylethanol, 2-methoxyphenols substituted in position 4 with an alkyl or alkenyl radical, as well as mixtures of two or more of them in all proportions.

6. The composition as claimed in claim, wherein the at least one odor masking agent b) comprises at least one ester b2) is selected from the group consisting of acetates, propionates, butyrates, methyl butyrates, pentanoates, hexanoates, heptanoates, benzoates, hydroxybenzoates, cyclopropylcarboxylates, cyclobutylcarboxylates, cyclopentylcarboxylates, cyclohexylcarboxylates, citrates, caproates, oleates, linoleates, linolenates, of linear or branched alkyl, of linear or branched alkenyl comprising from 3 to 12 carbon atoms, of aryl, of terpene derivatives, the lactones, and mixtures thereof.

7. The composition as claimed in claim 1, wherein the at least one odor masking agent b) comprises one or more aldehydes b3) selected from the group consisting of propanal, butanal, pentanal, hexanal, heptanal, octanal, nonanal, decanal, undecanal, dodecanal, benzaldehyde, geranial, neral, citronellal, hydroxydecanals, phenylpropanals, phenylbutanals, phenylpentanals, phenylhexanals, hydroxybenzaldehydes, alkoxybenzaldehydes, as well as the substituted homologs thereof, and mixtures of two or more of these aldehydes, in all proportions.

8. The composition as claimed in claim 1, wherein the at least one odor masking agent b) comprises one or more ketones b4) selected from the group consisting of propanone, butanone, pentanone, hexanone, heptanone, octanone, nonanone, decanone, undecanone, dodecanone, menthone, iso-menthone, ionones, methylionones, phenylethanones, benzopyranones, 1,8-cineole, ascaridole, flavonone, calone, galbascone, as well as the substituted homologs thereof, and mixtures of two or more of these ketones, in all proportions.

9. The composition as claimed in claim 1, wherein the at least one odor masking agent b) comprises one or more ethers b5) selected from the group consisting of optionally substituted dialkyl ethers, pyrans, furans, benzopyrans, benzofurans, naphthopyrans, naphthofurans, as well as the substituted homologs thereof, and mixtures of two or more of these ethers, in all proportions.

10. The composition as claimed in claim 1, further comprising, in minor amounts, one or more other agents (fragrances) selected from the group consisting of fatty acids, glycols, terpene compounds, as well as one or more additives selected from the group consisting of solvents, pigments, dyes, preservatives, and biocides.

11. The composition as claimed in claim 1, wherein the odor masking agent comprises:
at least 1 wt %, of at least one alcohol b1), selected from the group consisting of benzyl alcohol, phenylethanol, propylethanol and butylethanol, and mixtures thereof in all proportions,
at least 1 wt %, of at least one ester b2), selected from the group consisting of benzyl acetate, phenylethyl acetate, methyl 2-hydroxybenzoate, benzyl 2-hydroxybenzoate, butyrolactones, and hexanolides comprising from 6 to 12 carbon atoms, and mixtures thereof in all proportions,
at least 1 wt %, of at least one aldehyde b3), selected from the group consisting of 3-(4-ethylphenyl)-2,2-dimethylpropanal, 3-(2-ethylphenyl)-2,2-dimethylpropanal, 7-hydroxydecanal, 7-hydroxy-3,7-dimethyloctanal, 2-methoxybenzaldehyde, 4-methoxybenzaldehyde, and mixtures thereof in all proportions, and
the complement to 100% comprising at least one ketone b4) and/or at least one ether b5) and/or one or more other fragrances and/or additives selected from the group consisting of solvents, pigments, dyes, preservatives, and biocides.

12. The composition as claimed in claim 1, wherein the odor masking agent comprises:
at least 1 wt %, of at least one ester b2), selected from the group consisting of the cyclic esters of the alkanolide type,
at least 1 wt %, of at least one ketone b4), selected from the group consisting of menthone, iso-menthone, ionones, methylionones, phenylethanones, benzopyranones, 1,8-cineole, ascaridole, flavonone, calone, galbascone, as well as the substituted homologs thereof, and mixtures of two or more of these ketones, in all proportions,
at least 1 wt %, of at least one ether b5), selected from the group consisting of optionally substituted dialkyl ethers, pyrans, furans, benzopyrans, benzofurans, naphthopyrans, naphthofurans, as well as the substituted homologs thereof, and mixtures of two or more of these ethers, in all proportions, and
the complement to 100% comprising at least one alcohol b1) and/or at least one aldehyde b3) and/or one or more other fragrances and/or additives selected from the group consisting of solvents, pigments, dyes, preservatives, and biocides.

13. A method for attenuating or else masking the odor of at least one poly(phenol sulfide), or of a composition comprising at least one poly(phenol sulfide), comprising combining the at least one poly(phenol sulphide or composition comprising at least one poly(phenol sulphide) with at least one odor masking agent comprising at least one compound selected from the group consisting of b1) alcohols, b2) esters, b3) aldehydes, b4) ketones and b5) ethers.

14. A method, comprising using the composition as claimed in claim 1 as an antioxidant and/or thermal stabilizer for plastics or for oils, as a flame retardant for plastics or else for synthetic or vegetable fibers, as a protective agent for wood, as an agent for dismutation and bleaching of vegetable resins, or as a charge control agent for toners.

15. A manufactured product prepared with at least one composition as claimed in claim 1.

16. The manufactured product as claimed in claim 15, wherein the manufactured product is selected from the group consisting of elastomers, tires and parts of tires, products based on thermoplastic resins, masterbatches, products based on rosin, products based on vegetable fibers, products based on polystyrene foam, the components of toners for printing, and products based on wood treated with poly(phenol sulfides).

17. The composition as claimed in claim 1, wherein the composition comprises from 0.001 to 1% by weight relative to the total weight of the composition of the at least one odor masking agent.

18. The composition as claimed in claim 1, wherein the odor masking agent b) comprises at least 1 wt % of at least one alcohol b1), at least 1 wt % of at least one ester b2), at least 1 wt % of at least one aldehyde b3), and the complement to 100% comprising at least one ketone b4) and/or at least one ether b5) and/or one or more other fragrances and/or additives.

19. The composition as claimed in claim 1, wherein the odor masking agent b) comprises at least 10 wt % of at least one alcohol b1), at least 10 wt % of at least one ester b2), at least 10 wt % of at least one aldehyde b3), and the complement to 100% comprising at least one ketone b4) and/or at least one ether b5) and/or one or more other fragrances and/or additives.

20. The composition as claimed in claim 1, wherein the odor masking agent b) comprises at least 10 wt % of at least one ester b2), at least 10 wt % of at least one ketone b4), at least 10 wt % of at least one ether b5), and the complement to 100% comprising at least one alcohol b1) and/or at least one aldehyde b3) and/or one or more other fragrances and/or additives.
